(19) United States
(12) Patent Application Publication
(10) Pub. No.: US 2017/0368582 A1
(43) Pub. Date: Dec. 28, 2017

(54) Cleaning Device

(71) Applicants: Tracy Lynn Zackson, Olivette, MO (US); Saul Leon Zackson, Olivette, MO (US)

(72) Inventors: Tracy Lynn Zackson, Olivette, MO (US); Saul Leon Zackson, Olivette, MO (US)

(21) Appl. No.: 15/193,076

(22) Filed: Jun. 26, 2016

(51) Int. Cl. B08B 9/087; B08B 13/00; A46B 5/00

(52) U.S. Cl. CPC B08B 9/087; A46B 5/005; B08B 13/00

(57) ABSTRACT

A cleaning device for cleaning inner surfaces of an object such as a bottle or vase. A device includes a shaft, a slidably coupled runner, a hub, arms pivotally coupled to the hub, stretchers, cleaning heads attached to the tips of the arms, and arm rod coupled to the runner. The arms can include wiping material along their length. When retracted, the device can be inserted into an object. Pushing on the rod leads to extension of the arms. The extended arms can be held in place by a securing means such as a set screw. The device can then be moved rotationally, translationally or both relative to the object. The securing means can then be released, and the arms can be retracted by pulling the rod. The device can be removed from the object, and the cleaning heads can be removed.

### INTRODUCTION

The present invention relates generally to cleaning devices and methods for cleaning objects that include surfaces that are difficult to reach, such as bottles and vases.

Many objects including hollow objects, such as, for example, a bottle or a vase, can include portions or areas that are difficult or impossible to clean. Such objects can have the inner walls or an inner base that can be inaccessible, or difficult or impossible to reach by hand or with a brush or similar cleaning device. New cleaning devices are needed.

### SUMMARY

The present inventors have developed cleaning devices that can be used for cleaning bottles, vases and other objects that have internal surfaces that can be difficult to reach.

In various embodiments, a cleaning device of the present teaching can comprise, consist essentially of, or consist of a shaft; a slidably coupled runner which can move along the shaft; a hub that is continuous with the shaft or attached to the shaft; at least one arm that is pivotally coupled to the hub; at least one cleaning head attached to a tip of the at least one arm; at least one stretcher, each stretcher extending between the runner and an arm; and a rod coupled to the runner. In some configurations, the rod can be pivotally coupled to the runner. In some configurations, the rod can be fixedly coupled to the runner. In some configurations, the rod can be substantially parallel to the shaft.

In various embodiments, a cleaning device of the present teaching can comprise, consist essentially of, or consist of a shaft; a slidably coupled runner which can move along the shaft; at least one arm that is pivotally coupled to the shaft, a hub that is attached to or integral to the shaft; at least one cleaning head attached to a tip of the at least one arm; at least one stretcher, each stretcher extending between the runner and an arm; a bracket attached to the shaft; and a rod coupled to the runner, wherein the rod is connected to the runner and slidably engaged to the bracket. In some configurations, the rod can be substantially parallel to the shaft.

In some configurations, a hub can be an extension of the shaft or a separate structure attached to the shaft. In some configurations, a hub can be positioned at or near an end of the shaft. In some configurations, a hub can serve as a cap at one end of a shaft.

In various configurations, a cleaning device can further comprise a handle attached to the shaft, and can be, for example, attached at the end of a shaft opposite to that of a hub. In some aspects, a handle can be an integral part of the shaft, such as a bend in the shaft. In various configurations, a cleaning device can further comprise a handle attached to the rod.

In various configurations, a cleaning device of the present teachings can include means for reversibly securing the rod to the shaft or bracket, such as, for example and without limitation, a screw, a clip, a vise, a clamp, a clasp, a ring, a bracket or any combination thereof. A screw can be, for example, a set screw.

In various configurations, a cleaning device of the present teachings can include a clamp or bracket that can include a guide for the rod. In some aspects, the clamp or bracket can be stationery with respect to the shaft, but can allow the rod to slide through. In various aspects, a securing means can be used to secure the device in a selected position with regard to extension of the arm(s). In some aspects, the securing means can be configured for reversibly securing the rod to the bracket at a user-selected position. In some aspects, the securing means can be or can comprise, consist essentially of, or consist of a screw, a clip, a vise, a clamp, a clasp, or any a combination thereof. In some aspects, the securing means can comprise, consist essentially of, or consist of a screw such as a set screw, which can be operatively positioned for reversibly securing the rod to the bracket.

In some configurations, a cleaning head can comprise a cleaning surface that, in use, directly contacts an object to be cleaned. A cleaning surface can be, without limitation, a sponge, a cloth, a brush or a combination thereof. In some configurations, a cleaning surface can include any sort of abrasive, scrubbing or absorbent material, for example and without microfiber cloth; nylon cloth; a plastic such as polypropylene; brush bristles such as synthetic or natural bristles, e. g., nylon, polyester, polypropylene bristles; animal hair bristles such as hog bristles; cellulose sponge; synthetic sponge; rubber; a modified rubber such as silicone rubber, graphite-coated rubber or polytetrafluoroethylene-coated rubber; sand paper; or polypropylene fiber combined with aluminum oxide (e.g., Scotch-Brite™, 3M Corporation, St. Paul, Minn.).

In various configurations, a cleaning head of a cleaning device of the present teachings can be permanently attached to an arm, or reversibly attached to an arm. In some configurations, a cleaning head can be detachably attached to an arm. In some configurations, a cleaning head can comprise a cleaning surface attached to a solid support or backing. In some configurations, a solid support can include means for reversibly attaching a cleaning head to an arm. Such means can be, for example, a screw, a clip, a clasp, a clamp or a Velcro pad extending from or attached to the solid support, with a corresponding means for receiving the attaching means at or near a tip of an arm. Such corresponding means for receiving the attaching means can be, for example, a threaded screw hole in an arm, a Velcro pad, or an arm extension configured to receive a clip or a clamp.

In some configurations, a means for reversibly attaching a cleaning head to an arm can include, for example, attachment means extending from or near the tip of an arm such as, without limitation, a screw, a clip, a clasp, a clamp or a Velcro pad. A cleaning head can include corresponding means for receiving the means for reversibly attaching a cleaning head, and can be, for example and without limitation, a threaded screw hole in a solid support, a Velcro pad, or a mount configured to receive a clip, a clasp, or a clamp.

In some configurations, a cleaning device of the present teachings can further comprise a wiper or a wiping means such as a wiping surface or wiping material affixed along an arm. In various aspects, a wiping surface or material can be, for example, a brush surface, a sponge, brush bristles, rubber, or a modified rubber such as silicone rubber, graphite-coated rubber or polytetrafluoroethylene-coated rubber. In various configurations, the wiping surface can be configured to be reversibly attached to an arm.

In some configurations, a stretcher of a cleaning device of the present teachings can be pivotally attached to a runner. In some configurations, a stretcher of a cleaning device of the present teachings can be pivotally attached to an arm. This attachment can be at the end of the stretcher opposite to that of the pivotal attachment of the stretcher to the runner.

In various configurations, a cleaning device of the present teachings can include 1 arm, or 2 or more arms, 3 or more arms, 4 or more arms, 5 or more arms, 6 or more arms, 7 or more arms, or 8 or more arms. In some preferred configurations, a cleaning device can have 2, 3, or 4 arms. In configurations with multiple arms, the arms can be disposed symmetrically around the shaft or hub, or asymmetrically around the shaft or hub.

In various configurations, a shaft can comprise a spring mechanism coupled to the runner, for extending the one or more arms. In various configurations, a shaft can comprise one or more internal screw mounts, thereby allowing for addition of extensions to the shaft.

In use, prior to insertion into an object to be cleaned, a cleaning device of the present teachings can be in a retracted position. A user can pull on the rod for maximum retraction. The user can secure the device in a retracted position by employing a securing means, e.g., by tightening a set screw. The user can insert the device into the object to be cleaned, provided the object has an opening sufficiently wide for accepting the device in a retracted conformation. Following insertion of the device into an object to be cleaned, the user can release the securing means, e.g., by loosening a set screw. The user can push the rod forward, thereby moving the runner along the shaft and extending the arm(s). In response to the movement of the rod, the cleaning head(s) extend away from the shaft and can contact the wall(s) of the object. The user can secure the device in an extended position by employing a securing means, e.g., by tightening a set screw. Cleaning of the inner walls of the object can be effected by moving the device translationally, rotationally or both relative to the object when the arm(s) of the device are in an extended conformation. In addition, wiping surface(s) extending along the arm(s) and the end of the shaft or hub can contact the inner base of the object. Cleaning of the inner base of the object can be effected by moving the device translationally, rotationally or both relative to the object when the device is in an extended conformation. To remove the device from the object, the user can release the securing means, e.g., by loosening a set screw, and can then pull on the rod, thereby retracting the arms. The user can then pull the device out of the object.

A user can choose from among different types of interchangeable cleaning heads and wiping materials, and can attach and remove them as desired.

In various embodiments, a cleaning device of the present teachings can be made by standard mechanical device manufacturing methods, such as, for example and without limitation, by production on a 3-dimensional printer, or by shaping and assembling materials such as sticks, wires, pipes, sponges, rubber, screws, cloth, plastics such as thermoplastics, or any other solid materials by methods well known to skilled artisans.

### BRIEF DESCRIPTION OF THE DRAWINGS

FIG. 1 illustrates an embodiment of a cleaning device of the present teachings.

FIG. 2 illustrates an embodiment of a cleaning device of the present teachings.

FIG. 3 illustrates a cleaning head which attaches to an arm of a device of the present teachings.

### DETAILED DESCRIPTION

The present inventors have developed cleaning devices that can be used to clean inner surfaces of bottles, vases, and other objects. In some embodiments, a cleaning device of the present teachings can include a shaft; a slidably coupled runner; at least one pivotally coupled arm; at least one cleaning head attached to the at least one pivotally coupled arm; at least one stretcher, each stretcher extending between the runner and a pivotally coupled arm; and a rod substantially parallel to the shaft and coupled to the runner. In some embodiments, a cleaning device of the present teachings can include a shaft; a slidably coupled runner; at least one pivotally coupled arm; at least one cleaning head attached to the at least one pivotally coupled arm; at least one stretcher, each stretcher extending between the runner and a pivotally coupled arm; a bracket attached to the shaft; and a rod substantially parallel to the shaft, wherein the rod is affixed to the runner and slidably engaged to the bracket.

In various configurations, a shaft of a cleaning device of the present teachings can be solid or hollow, and can be made of wood, plastic, metal, or a combination thereof. In some configurations, a shaft of the present teachings can be cylindrical in shape. In cross section, a shaft can be circular, or other shape such as, without limitation, triangular, rectangular, square, 5-sided, 6-sided, 7-sided, or 8-sided. In various aspects, a shaft can be of any desired length such as, for example and without limitation, from 3 inches, about 4 inches, about 5 inches, about 6 inches, about 7 inches, about 8 inches, about 9 inches, or about 10 inches in length, up to about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30 inches, or greater, in length. In various aspects, a shaft can be of any desired thickness such as, for example and without limitation, from about ⅛ inch, about ¼ inch, about ⅜ inch, about ½ inch, about ⅝ inch, about ¾ inch, about ⅞ inch, or about 1 inch in diameter or longest cross-sectional length, up to about 1¼ inch, about 1½ inch, about 1¾ inch, or greater in diameter or longest cross-sectional length. In various aspects, a shaft can be substantially round or substantially flat.

In various configurations, a rod of a cleaning device of the present teachings can be solid or hollow, and can be made of wood, plastic, metal, or a combination thereof. In some configurations, a rod of the present teachings can be cylindrical in shape. In cross section, a rod can be circular, or other shape such as, without limitation, triangular, rectangular, square, 5-sided, 6-sided, 7-sided, or 8-sided. In various aspects, a rod can be of any desired length such as, for example and without limitation, from about 3 inches, about 4 inches, about 5 inches, about 6 inches, about 7 inches, about 8 inches, about 9 inches, or about 10 inches in length, up to about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30 inches, or greater, in length. In various aspects, a rod can be of any desired thickness such as, for example and without limitation, from about ⅛ inch, ¼ inch, about ⅜ inch, about ½ inch, about ⅝ inch, about ¾ inch, about ⅞ inch, or about 1 inch in diameter or longest cross-sectional length, up to about 1¼ inch, about 1½ inch, about 1¾ inch, or greater in diameter or longest cross-sectional length. In various configurations, a rod can be of about the same length, shorter, or longer than a shaft. In various aspects, a rod can be substantially round or substantially flat.

In various configurations, an arm of a cleaning device of the present teachings can be solid or hollow, and can be made of wood, plastic, metal, or a combination thereof. In some configurations, an arm of the present teachings can be cylindrical in shape. In cross section, an arm can be circular, or other shape such as, without limitation, triangular, rectangular, square, 5-sided, 6-sided, 7-sided, or 8-sided. In various aspects, an arm can be of any desired length such as, for example and without limitation, from about 3 inches, about 4 inches, about 5 inches, about 6 inches, about 7 inches, about 8 inches, about 9 inches, or about 10 inches in length, up to about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30 inches, or greater, in length. In various aspects, an arm can be of any desired thickness such as, for example and without limitation, from about ⅛ inch, about ¼ inch, about ⅜ inch, about ½ inch, about ⅝ inch, about ¾ inch, about ⅞ inch, or about 1 inch in diameter or longest cross-sectional length, up to about 1¼ inch, about 1½ inch, about 1¾ inch, or greater in diameter or longest cross-sectional length. In various configurations, an arm can be of about the same length, shorter, or longer than a shaft. In various aspects, an arm can be substantially round or substantially flat.

In various configurations, a stretcher of a cleaning device of the present teachings can be solid or hollow, and can be made of wood, plastic, metal, or a combination thereof. In some configurations, a stretcher of the present teachings can be cylindrical in shape. In cross section, an ann can be circular, or other shape such as, without limitation, triangular, rectangular, square, 5-sided, 6-sided, 7-sided, or 8-sided. In various aspects, a stretcher can be of any desired length such as, for example and without limitation, from about 3 inches, about 4 inches, about 5 inches, about 6 inches, about 7 inches, about 8 inches, about 9 inches, or about 10 inches in length, up to about 11 inches, about 12 inches, about 13 inches, about 14 inches, about 15 inches, about 16 inches, about 17 inches, about 18 inches, about 19 inches, about 20 inches, about 21 inches, about 22 inches, about 23 inches, about 24 inches, about 25 inches, about 26 inches, about 27 inches, about 28 inches, about 29 inches, or about 30 inches, or greater, in length. In various aspects, a stretcher can be of any desired thickness such as, for example and without limitation, from about ¼ inch, about ⅜ inch, about ½ inch, about ⅝ inch, about ¾ inch, about ⅞ inch, or about 1 inch in diameter or longest cross-sectional length, up to about 1¼ inch, about 1½ inch, about 1¾ inch, or greater in diameter or longest cross-sectional length. In various aspects, a stretcher can be substantially round or substantially flat. In various configurations, a stretcher can be of about the same length, shorter, or longer than a shaft. In various configurations, one end of a stretcher can be pivotally attached to the runner; the opposite end of the stretcher can be pivotally attached to an arm, at a position effective for reversibly extending the arm, for example and not limited to: approximately the midpoint of the arm; about a quarter of the distance from the shaft or hub to the tip of the arm; or about three quarters of the distance from the shaft or hub to the tip of the arm.

In various configurations a cleaning device of the present teachings can include a wiping surface or wiping material affixed to an arm. In various aspects, a wiping surface can be, for example, a brush surface, a sponge, brush bristles, rubber, a cloth such as microfiber cloth, or a modified rubber such as silicone rubber, graphite-coated rubber or polytetrafluoroethylene-coated rubber. In various configurations, the wiping surface can be configured to be reversibly attached to an arm.

In various configurations, a cleaning head of a cleaning device of the present teachings can comprise a cleaning surface such as, without limitation, a sponge, a cloth, a brush or a combination thereof. In use, the cleaning surface can directly contact an object to be cleaned. In some configurations, a cleaning surface can include any sort of abrasive, scrubbing or absorbent material, for example and without limitation, microfiber cloth, nylon cloth, polypropylene, brush bristles such as synthetic or natural bristles, e. g., nylon, polyester, polypropylene bristles, or animal hair bristles such as hog bristles, cellulose sponge, synthetic sponge, rubber, a modified rubber such as silicone rubber, graphite-coated rubber, polytetrafluoroethylene-coated rubber, sand paper, rubber, or polypropylene fiber combined with aluminum oxide (e.g., Scotch-Brite™, 3M Corporation, St. Paul, Minn.). In some configurations, a cleaning surface can be backed by a solid support, such as a solid piece of plastic, metal, wood, or other material A cleaning surface can be of any convenient or suitable shape, material or size, such as, for example, a circular sponge of from about 5 mm, about 10 mm, about 20 mm, about 30 mm, or about 40 mm in diameter, to about 50 mm, about 60 mm, about 70 mm, about 80 mm, about 90 mm, about 100 mm in diameter, or larger. In some aspects, a cleaning surface can be non-circular, e.g., oval, triangular, square, rectangular, 5-sided, 6-sided, 7-sided, or 8-sided, and can be symmetrical or asymmetrical in shape. In various aspects, the surface area of a cleaning surface can range from about 10 mm², about 11 mm², about 12 mm², about 13 mm², about 14 mm², about 15 mm², about 16 mm², about 17 mm², about 18 mm², about 19 mm², about 20 mm², about 21 mm², about 21 mm², about 23 mm², about 24 mm², about 25 mm², about 21 mm², about 21 mm², about 21 mm², about 21 mm², about 21 mm², about 21 mm², about 21 mm², about 22 mm², about 23 mm², about 24 mm², about 25 mm², about 26 mm², about 27 mm², about 28 mm², about 29 mm², about 30 mm², about 31 mm², about 32 mm², about 33 mm², about 34 mm², about 35 mm², about 36 mm², about 37 mm², about 38 mm², about 31 mm², about 31 mm², about 31 mm², about 31 mm², about 31 mm², about 31 mm², about 39 mm², about 40 mm², about 41 mm², about 42 mm², about 43 mm², about 44 mm², about 45 mm², about 46 mm², about 47 mm², about 48 mm², about 49 mm², about 50 mm², about 100 mm², about 150 mm², about 200 mm², about 250 mm², about 300 mm², about 350 mm², about 400 mm², about 450 mm², about 450 mm², or about 500 mm², up to about 1,000 mm², about 2,000 mm², about 3,000 mm², about 4,000 mm², about 5,000 mm², about 6,000 mm², about 7,000 mm², about 8,000 mm², about 9,000 mm², about 10,000 mm², or greater.

In various configurations, a cleaning head can include means for attachment to an arm of a cleaning device of the present teachings. In some aspects, the means for attachment can be reversible means, such as, for example, a screw, a clip, a clasp, a clamp, a vise, or a Velcro pad, with a corresponding means situated at or near a tip of an ann. A screw can be of any convenient length, e.g., from about 2 mm, about 3 mm, 4 about mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, or about 25 mm, up to about 50 mm, about 60 mm, about 70 mm, about 80 mm, about 90 mm, about 100 mm, or longer.

In various configurations, a cleaning device of the present teachings can also include a shaft handle. The handle can be part of or attached to the base of the shaft, and can be, for example, a bend in the shaft such that the shaft is overall “J”-shaped. In some aspects, the handle can be a component separate from the shaft, or can be integral to the shaft. In various aspects, the handle can be of any desired length, for example and without limitation, from about 1 inch in length, or less, up to about 6 inches in length, or longer.

In various configurations, a cleaning device of the present teachings can include means for reversibly securing the rod to the shaft or bracket, such as, for example and without limitation, a screw, a clip, a vise, a clamp, a clasp or a combination thereof. A collar, bracket or similar structure can be fixedly attached to the shaft which allows the rod to slide relative to the shaft. The collar, bracket or similar structure can include means for receiving the securing means, such as, for example, a threaded screw hole. A screw can be, for example, a set screw, and can be, e.g., about 2 mm, about 3 mm, 4 about mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, about 21 mm, about 22 mm, about 23 mm, about 24 mm, or about 25 mm in length, or longer.

In various configurations, a cleaning device of the present teachings can also include a rod handle. The rod handle can be, for example and without limitation, a loop or a flat extension of the rod, and can facilitate a user's ability to push or pull the rod to effect extension or retraction of the arm(s).

### EXAMPLES

The present teachings include descriptions that are not intended to limit the scope of any aspect or claim. The examples and methods are provided to further illustrate the present teachings. Those of skill in the art, in light of the present disclosure, will appreciate that many changes can be made in the specific embodiments that are disclosed and still obtain a like or similar result without departing from the spirit and scope of the present teachings. As used herein, the singular forms “a”, “an” and “the” are intended to include the plural forms as well, unless the context indicates otherwise. All publications cited herein are incorporated by reference, each in its entirety. Applicant reserves the right to challenge any conclusions presented by any of the authors of any reference.

### Example 1

This example illustrates a configuration of an embodiment of a cleaning device of the present teachings.

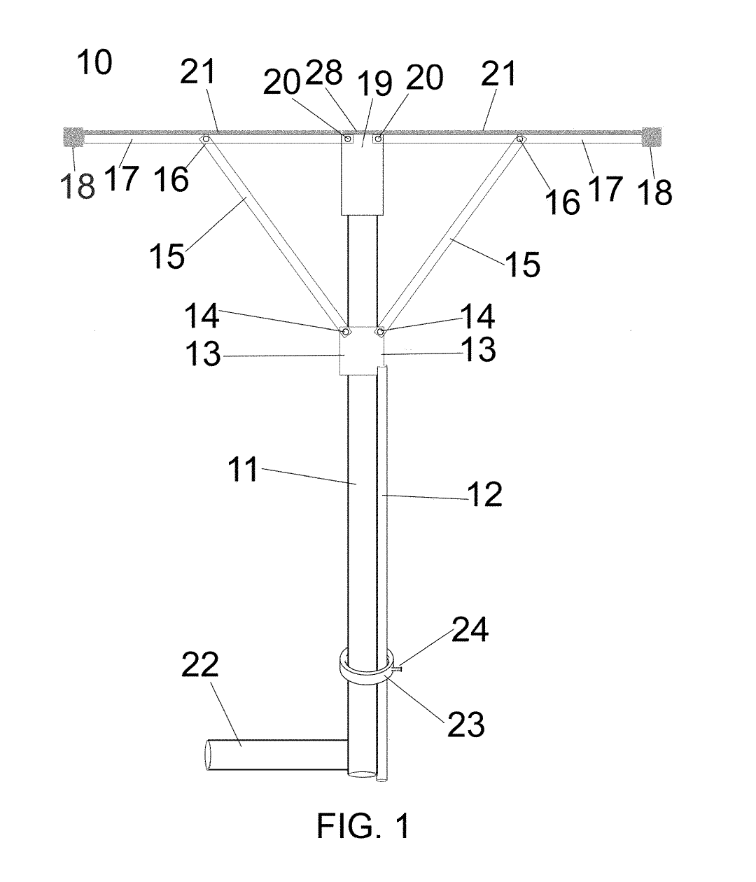

As shown in FIG. 1, a cleaning device 10 has a shaft 11. A hub 19 is located at one end of the shaft 11. A handle 22 is located at the opposite end of the shaft 11. 2 arms 17 are pivotally attached at pivots 20 to the hub 19. A runner 13 can slide along the shaft 11. A rod 12 is attached to the runner 13, and extends to approximately the length between the runner 13 and the base of the shaft 11 at the handle 22 when the arms 17 are maximally extended, or can be of another convenient length. A rod handle such as a flat handle or a loop (not shown) or other means for a user to grasp the rod 12 can be included on the rod 12 to facilitate pushing or pulling the rod 12 relative to the shaft 11. Means for reversibly securing the rod 12 to the shaft 11 are shown as a ring 23 that is attached to the shaft 11, and a set screw 24. The ring 23 includes a threaded opening for receiving the set screw 24. The set screw 24 can be used to reversibly lock or secure the rod 12 in place, with the arms 17 in a retracted or extended position.

The device as shown also includes 2 stretchers 15. Each stretcher is pivotally attached to the runner 13 at a pivot 14, and is pivotally attached to an arm 17 at a pivot 16. An arm 17 can have attached along its length a wiping material 21, such as, for example, sponge, rubber, brush bristles or microfiber fabric, and can be used to clean the inner base of an object. Wiping material of an end cover 28 of the hub or shaft can further aid the cleaning of the inner base of an object. An arm 17 also has attached at its tip a cleaning head 18.

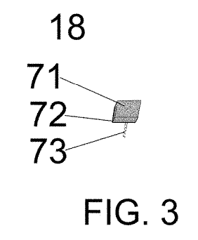

As shown in FIG. 3, a cleaning head 18 includes a cleaning surface 71 such as, for example, sponge, rubber, brush bristles or microfiber fabric, and can be used to clean the inner walls and inner base of an object such as a bottle or vase. A cleaning head can also include a support backing 72, and a means for attachment to an arm 17, such as a screw 73, Velcro, a clamp, a clasp, other attachment. The tip of an arm can include corresponding means for receiving the screw 73, for example a mount for receiving a screw, such as a hole comprising a screw thread (not shown), Velcro, clamp, clasp, other attachment means. Alternatively, a tip of an arm 17 can include a screw, a Velcro pad, a clamp, a clasp, or other attachment means for securing a cleaning head 18 to an arm 17. A cleaning head can include corresponding means for receiving the screw such as a hole comprising a screw thread (not shown), or other corresponding attachment components such as Velcro or supports for a clamp, a clasp, or other attachments.

### Example 2

This example illustrates a configuration of an embodiment of a cleaning device of the present teachings.

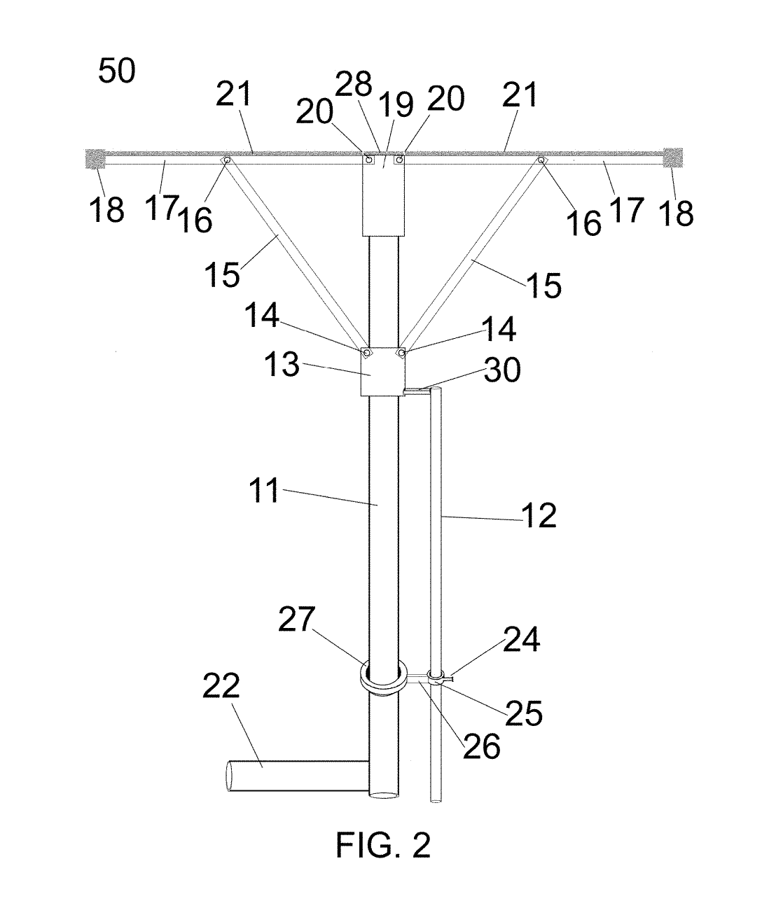

As shown in FIG. 2, a cleaning device 50 has a shaft 11. A hub 19 is located at one end of the shaft 11. In the configuration as shown, 2 arms 17 are each pivotally attached at a pivot 20. A runner 13 can slide along the shaft. A rod 12 is attached to a post 30 which in turn connects to the runner 13. The rod 12 can move parallel to the shaft H, and can be of a convenient length, such as, for example, a length sufficient to extend between the base of the shaft 11 at the handle 22 and the post 30 when the arms 17 are maximally extended. Means for reversibly securing the rod 12 to the shaft 11 are shown as a bracket 27, an extension 26, a guide ring 25, and a set screw 24. The rod 12 can move through the guide ring 25. The guide ring 25 includes a threaded opening for receiving the set screw 24. The set screw 24 can be tightened to secure the rod 12 in place, thereby maintaining the arms 17 in a retracted or extended position, or the set screw 24 can be loosened to allow the rod 12 to be moved relative to the shaft 11, thereby allowing for repositioning of the arms.

The device as shown also includes 2 stretchers 15. Each stretcher is pivotally, attached to the runner 13 at a pivot 14, and is pivotally attached to an arm 17 at a pivot 16. An arm 17 can have attached along its length a wiping material 21, such as, for example, sponge, rubber, brush bristles or microfiber fabric, and can be used to clean the inner base of an object. Wiping material of an end cover 28 of the hub or shaft can further aid the cleaning of the inner base of an object.

An arm also has attached at its tip a cleaning head 18, as described above.

### Example 3

This example illustrates a non-limiting use of a cleaning device of the present teachings.

Cleaning pads 18 with sponge surfaces 71 as shown in FIG. 3 are each attached to an arm 17 of a device 10 as illustrated in FIG. 1. A few drops of dish detergent are added to the sponge surfaces 71 and to wiping material 21 and 28. The set screw 24 is rotated counterclockwise to release the rod 12. Rod 12 is pulled back, resulting in arms 17 swinging against shaft 11. Set screw 24 is tightened by clockwise rotation, and the device 10 is inserted into a vase to be cleaned while holding handle 22. Set screw 24 is loosened by counterclockwise rotation, and rod 12 is then pushed until the arms are maximally extended. Set screw 24 is then tightened by clockwise rotation, securing the arms 17 in place relative to the shaft. The cleaning heads 18 can contact the inner walls, and the wiping materials 21 and 28 can contact the inner base of the vase. The user then moves the device relative to the vase, by rotation, translation or a combination thereof, thereby releasing dust and dirt from the inner walls and base of the vase and causing dust and dirt to accumulate on the cleaning pads 18 and wiping material 21 and 28. Set screw 24 is then loosened by counterclockwise rotation. The rod is then pulled back, resulting in the arms swinging against the shaft. Set screw 24 is then tightened, and the device is then pulled out from the vase. The cleaning pads 18 and wiping material 21 and 28 are then detached, and can be cleaned for re-use, or disposed of.

What is claimed is:

1. A cleaning device comprising:
a shaft;
a slidably coupled runner;
a hub;
at least one arm pivotally coupled to the hub;
at least one cleaning head attached to the tip of at least one pivotally coupled arm;
at least one stretcher, each stretcher extending between the runner and a pivotally coupled arm; and
a rod coupled to the runner.

2. A cleaning device in accordance with claim 1, wherein the rod is substantially parallel to the shaft.

3. A cleaning device in accordance with claim 1, further comprising a means for reversibly securing the rod to the shaft.

4. A cleaning device in accordance with claim 3, wherein the means for reversibly securing the rod to the shaft is selected from the group consisting of a screw, a clip, a vise, a clamp, a clasp, a ring, a bracket and a combination thereof.

5. A cleaning device in accordance with claim 1, further comprising a handle attached to or extending from the shaft.

6. A cleaning device in accordance with claim 1, further comprising a screw operatively positioned for reversibly securing the rod to the shaft.

7. A cleaning device in accordance with claim 1, wherein the at least one cleaning head comprises at least one cleaning surface selected from the group consisting of a sponge, a cloth, a brush, a wiper and a combination thereof.

8. A cleaning device in accordance with claim 7, wherein the cloth is a microfiber cloth.

9. A cleaning device in accordance with claim 7, wherein the at least one cleaning surface is affixed to a support.

10. A cleaning device in accordance with claim 1, further comprising a wiping material affixed to at least one arm.

11. A cleaning device comprising:
a shaft;
a slidably coupled runner;
a hub;
at least one arm pivotally coupled to the hub;
at least one cleaning head attached to the tip of at least one pivotally coupled arm;
at least one stretcher, each stretcher extending between the runner and a pivotally coupled arm;
a rod coupled to the runner; and
a bracket comprising a guide for the rod.

12. A cleaning device in accordance with claim 11, wherein the rod is substantially parallel to the shaft.

13. A cleaning device in accordance with claim 11, further comprising a means for reversibly securing the rod to the bracket.

14. A cleaning device in accordance with claim 13, wherein the means for reversibly securing the rod to the bracket is selected from the group consisting of a screw, a clip, a vise, a clamp, a clasp, and a combination thereof.

15. A cleaning device in accordance with claim 11, further comprising a screw operatively positioned for reversibly securing the rod to the bracket.

16. A cleaning device in accordance with claim 11, further comprising a handle attached to or extending from the shaft.

17. A cleaning device in accordance with claim 11, wherein the at least one cleaning head comprises at least one cleaning surface selected from the group consisting of a sponge, a cloth, a brush, a wiper and a combination thereof.

18. A cleaning device in accordance with claim 17, wherein the cloth is a microfiber cloth.

19. A cleaning device in accordance with claim 17, wherein the at least one cleaning surface is affixed to a support.

20. A cleaning device in accordance with claim 11, further comprising a wiping material affixed to at least one arm.
